(19) United States
(12) Patent Application Publication
(10) Pub. No.: US 2008/0292754 A1
(43) Pub. Date: Nov. 27, 2008

(54) Instant Food Comprising Flavour Capsules

(76) Inventors: Jun Katada, Yokohama-City Kanagawa (JP); Laetitia Nicolas, St-Julien-En-Genevois (FR); Takao Sushida, Kashiwa-City (JP)

Correspondence Address: WINSTON & STRAWN LLP;PATENT DEPARTMENT, 1700 K STREET, N.W., WASHINGTON, DC, 20006, US

(21) Appl. No.: 12/092,544

(22) PCT Filed: Dec. 6, 2006
(86) PCT No.: PCT/IB2006/054619

§ 371 Date: May 2, 2008

(30) Foreign Application Priority Data
Dec. 8, 2005 (EP) 05111842.0

(51) Int. Cl. A23L 1/22

(52) U.S. Cl. 426/62; 426/455

(57) ABSTRACT

The present invention relates to instant food products of flavor capsules that include yeast and, encapsulated therein, a flavoring ingredient or composition wherein the instant food has a water content of 13 wt % or less. The instant food may be a soup, noodles or a seasoning or topping.

### TECHNICAL FIELD

The present invention relates to instant food products comprising flavour capsules, to a method of flavouring instant food products, and to a topping comprising flavour capsules.

### BACKGROUND AND PRIOR ART

Instant food products generally are products that have a relatively long shelf life but may be prepared in a very short time, such as a few minutes, for example.

Flavours, on the other hand, are generally volatile compounds or compositions comprising volatile compounds, and are thus, a priori, not suitable for a long-term storage. After a few days, flavours in food products have evaporated from the food product and are no longer perceived during the consumption of the food product. Furthermore, flavours may be sensitive to oxygen exposure over time and thus degrade.

Encapsulation of a flavour brings an advantage in such a situation. However, a number of restrictions need to be fulfilled when using encapsulated flavours in food products having a long shelf life. Importantly, the flavours should not be released before preparation and/or consumption. Still, given the short preparation time of most instant foods, the flavours need to be released in a relatively short time at the moment the instant food product is prepared, providing the impression of freshness to the consumer. In addition, it is important that at least some flavour is not instantly released during the preparation time, but instead during consumption otherwise a high flavour impact is obtained during preparation, but no flavour is available any more during consumption.

It would be desirable to provide a flavoured instant food product in a way that flavours remain intact and do not evaporate or otherwise dissipate until preparation and/or consumption. It would be particularly desirable to have a certain flavour release during preparation of the instant food, for example by the addition of hot water, and an increased perception of the flavour during consumption.

Many flavour systems have been evaluated for use in instant foods to date. However, it is a constant objective to provide better taste to a consumer than comparable products already on the market.

The present invention seeks to address one or more of the abovementioned problems and/or to provide one or more of the abovementioned benefits.

### SUMMARY OF THE INVENTION

Accordingly, the present invention provides an instant food product comprising flavour capsules comprising yeast, and, encapsulated therein, a flavouring ingredients or composition, wherein the instant food product has a water activity below 0.5 when measured at 20° C.

In another aspect, the invention provides a method of preparing an instant food comprising the steps of
a) mixing yeast with water to obtain an aqueous mixture,
b) adding a flavour to the aqueous mixture,
c) stirring the aqueous mixture including the flavour until at least part of the flavour has passed into the yeast,
d) drying the resulting mixture,
e) adding the dried capsules to a dried instant food to produce an instant food having a water activity of 0.5 or less when measured at 20° C.

In yet another aspect, the invention provides a topping comprising dried vegetables and/or spices, and flavour capsules as defined above, the topping having a water activity of 0.5 or less when measured at 20° C.

In a further aspect, the invention provides an instant food product comprising dried instant noodles and a dried topping as defined herein.

### DETAILED DESCRIPTION

The present invention relates to an instant food product. The terms “instant food”, “instant product” or “food product” are also used interchangeably herein to refer to the instant food product of the present invention.

An instant food product is a food or beverage designed for quick preparation. Quick, for the purpose of the present invention, refers to a preparation time of 10 minutes or less.

The instant food product is, prior to reconstitution with liquid, a dry product. A “dry food product”, for the purpose of the invention, is a food product that has a water activity of below 0.5, preferably below 0.45, more preferably below 0.4, even more preferably below 0.35 or even below 0.3. Most preferably, the water activity is below 0.25, 0.2, 0.15 or even below 0.1.

This is key to the present invention because the inventors have found that when the food product is very dry, better stability of the flavour capsules that are part of the instant food can be achieved.

Water activity is measured with an Aqualab CX-2 apparatus (Decagon Devices, Inc., Pullman, Wash., USA). The apparatus is to be used according to the user's manual. In particular the thermostatic water bath connected to the apparatus is adjusted to 20° C. The procedure is started once the sample has been made thermostatic in the chamber foreseen for this and, at the end of the procedure, the temperature is checked to confirm that it is still at 20±0.5° C.

The dry instant food product preferably has a water content of equal to or less than 13 wt. %, more preferably equal to or less than 12 wt. %, even more preferably equal to or less than 11 wt. %. For example, the instant food product has a water content in the range of 3 to 10 wt. %, based on the total weight of the product.

In the context of the present invention, percentages or parts are generally percentages or parts by weight of dry matter, unless otherwise indicated, for example by reference to aqueous solutions or percentages of solids, where the percentages refer to parts of the total solution, including water.

In a preferred embodiment, the instant food is prepared by adding hot water to the instant food product. Hot water, for the purpose of the invention is water having a temperature of greater than 50° C., more preferably greater than 60° C., even more preferably greater than 70, 80 or even 90° C. After adding the water, the product is then ready for consumption after 0.5 to 10 minutes, preferably 2 to 8 minutes.

Alternatively, the instant food of the present invention may be prepared for consumption by boiling the instant food in water for the time periods indicated above.

The instant food of the present invention may be any instant food. For example, the instant food may be a complete meal or dish, including a starch source, vegetables and/or fruits, lipids and/or a protein source, for example from animal, fish and/or plant origin. If the food product is a complete meal, it is most preferably an instant soup.

Alternatively, the instant food may be an isolated food material that can be instantly prepared, for example instant mashed potatoes, pure instant rice, instant noodles and any other instantly preparable ingredient. Instant noodles are preferred.

If the instant food is instant noodles, it may comprise fried or air-dried instant noodles. Fried instant noodles are generally prepared by mixing and kneading raw materials such as flour, water and optionally other ingredients, rolling and sheeting the dough thus obtained. Further steps generally comprise cutting or forming the sheeted dough into noodle strips, gelatinising the noodle strips, for example by steam heating, and dehydrating, in this case in a short frying step, such that dried noodles are reconstituted faster. The dehydrated noodles may then be cooled down before optional mixing with other ingredients of the instant food and packaging.

For the sake of clarity it is stated that the term “noodles” is not intended to contain any limitation as to the form of these dough-based foods. Nevertheless, it is essential that it is dry.

For air-dried instant noodles, the frying step mentioned above is replaced by a longer steaming step and a drying step at elevated temperatures, for example 50-95° C. for generally 20-130 min, in order to prepare a dry product.

Of course, the instant noodles may comprise further raw materials, which may be added to the flour and the water in order to modify textural properties of the instant noodles. Examples include leavening agents, enzymes, modified starches, salts, flavours and flavour enhancers.

According to a still further embodiment, the instant food may be an instant seasoning, topping, dressing, sauce and/or gravy. Instant toppings or seasonings are preferred. Instant toppings are most preferred.

If the instant food is an instant topping, it may be prepared by it may be a fried, an air-dried or a freeze-dried topping. For instance, a topping comprising a vegetable is prepared by cutting the vegetable into small portions (e.g. having a length and width of about 0.1 to 10 mm), and the frying or air-drying the chopped vegetable in the manner described above. The vegetable may also be freeze-dried in any conventional manner.

Freeze dried instant foods are particularly desirable since this method of drying causes less damage to the substance than other dehydration methods. In particular, there is reduced risk of destroying or evaporating the sensitive flavour ingredients, especially volatile ingredients, when using this process. Furthermore, because freeze-dried products contain microscopic pores created by the ice crystals sublimating, these allow faster and easier rehydration of the dried food. This is clearly desirable in the context of instant foods.

The flavour capsules used in the instant food are preferably microcapsules, having a mean size in the range of 1-10 μm, preferably 2-8 μm, for example about 5 μm.

The flavour capsules comprise yeast, in which a flavouring ingredient or composition is encapsulated. The preparation of yeast encapsulating flavours has been disclosed in the art, for example in WO 03/041509 and EP 0528466, which disclose the use of such capsules in chewing gum, and also in WO 2005/067733.

A “flavouring ingredient or composition”, also referred to as “flavour” as used herein generally encompasses flavour ingredients or compositions of current use in the food industry, of both natural and synthetic origin. It includes single compounds and mixtures. The capsules used in the invention can encapsulate volatile or labile ingredients in liquid form, preferably with a log P in the range of −2 and 7, preferably 2-6. Specific examples of such components may be found in the current literature, e.g. in Fenaroli's Handbook of flavour ingredients, 1975, CRC Press; Synthetic Food adjuncts, 1947 by M. B. Jacobs, edited by Van Nostrand; or Perfume and Flavor Chemicals by S. Arctander, 1969, Montclair, N.J. (USA). These substances are well known to a person skilled in the art of flavouring or aromatising consumer products, i.e. of imparting an odour or a flavour or taste to a consumer product traditionally flavoured, or of modifying the taste of said consumer product. Natural extracts can also be encapsulated into the system flavouring the products of the invention. These include citrus extracts such as lemon, orange, lime, grapefruit, or mandarin oils or coffee, tea, mint, cocoa or essential oils of herbs and spices between other.

Examples of flavour ingredients or compositions are thus flavours of natural or synthetic origin. For example, synthetic flavour oils, flavouring aromatics, oils, essential oils, oleoresins and extracts derived from plants, for example from leaves, flowers, fruits, roots, rhizomes, stem, and so forth.

The flavour may be present in the form of a mixture with solvents, adjuvants, additives and/or other ingredients, for example those of current use in the flavour and/or food industry.

Preferably, the flavour ingredient or composition is liquid at 40° C., more preferably at 30° C., and most preferably at 25° C., at 1 atmosphere.

Preferably, the flavour capsules comprise an allium flavour. The allium flavour preferably comprises material selected from garlic, onion, chive, leek, scallion and combinations thereof. Preferably, the allium material is selected from the group consisting of an oil, oleoresin, extract, essence, puree, isolated compounds and combinations thereof. “Isolated compounds” are compounds contained in the above-indicated allium materials and which are added as synthetically manufactured or isolated compound as allium flavour or part of an allium flavour.

Examples of other flavours ingredients or compositions particularly preferred in the instant food of the present invention are flavour compositions of ginger, curry, basil, oregano, olive, shrimps, crab, sesame, scallop, soya, dried bonito, seaweed, pork, chicken, beef, for example. Such flavour compositions are commercially available.

In a preferred embodiment, the flavour capsules are obtainable by a process comprising the steps of
a) mixing yeast with water to obtain an aqueous mixture,
b) adding a flavour ingredient or composition to the aqueous mixture,
c) mixing the aqueous mixture including the flavour until at least part of the flavour has passed into the yeast,
d) drying the resulting mixture to a water activity of 0.5 or less when measured at 20° C. and also preferably to a water content of 13 wt % or lower.

Preferably, the aqueous mixture comprising the yeast and water is a suspension of 10-30 wt. %, preferably 15-25 wt.-% solids, depending on type of organism and equipment used.

According to a preferred embodiment of the present invention, the yeast cell wall is intact in order to effectively encapsulate and retain the flavors in the cells. Furthermore, a phospholipid bilayer is preferably present in the interior of the cell wall, in order to attract generally hydrophobic flavour compounds to diffuse into the interior of the yeast cell.

According to step b), at least one flavor is added to the aqueous mixture. Of course, the flavor could also be added earlier, for example, together with the yeast and the water. The flavor is usually present in a hydrophobic solvent, such as an essential oil, or dissolved in an oil. Therefore, the addition of the flavor may entail the formation of an emulsion. Accordingly, emulsifiers, surfactants and/or stabilizers may also be added to the aqueous liquid. Preferably, the dry-weight ratio of yeast to flavor in the aqueous liquid is in the range of 1:1 to 5:1, preferably 1.4:1 to 4:1.

According to step c) the aqueous mixture comprising the yeast, water and the material to be encapsulated is then mixed, preferably for 1 to 6 hours. After completion of step c), substantial amounts of the material to be encapsulated have passed through the cell wall into the yeast. Accordingly, in an embodiment, the encapsulated flavor is present within the cell wall of the yeast.

Step d) of the process provides drying of the resulting mixture so that a dried instant food is eventually obtained.

In a preferred embodiment, the process for obtaining capsules comprises the further step of adding a matrix component to the aqueous mixture. This step may be performed at various stages. For example, the matrix component may be added after step c). In this case, the resulting mixture to be dried has a higher dry matter content, which may reduce the costs of the drying step. In addition, a coating of the matrix component on the cells of the yeast is obtained.

Alternatively, the matrix component may be added to the aqueous mixture following a further step of removing the yeast comprising at least part of the flavour from the aqueous mixture. The yeast may be removed from the aqueous mixture by decantation and/or centrifugation, for example. Following this process alternative, the aqueous mixture, to which the matrix component is added, is largely free from yeast and may then be dried in this form, for example by spray drying. In a later step, dried capsules and dried matrix component may be recombined, if desired.

One advantage of the addition of a matrix component at any of the above-disclosed stages is that flavour compounds not entrapped by the cells of the yeast may be recovered by the matrix component. This is particularly relevant if complex flavour compositions comprising a number of different flavour compounds are to be encapsulated. The matrix component may then be suitable to bind more hydrophilic compounds, which are generally less efficiently encapsulated by the cells of a yeast.

Preferably, the matrix component is capable of forming a glassy matrix. A glassy matrix is an amorphous solid characterized by viscosities of the order in the range of about 10¹⁰ to 10¹² Pa·s and an extremely low molecular mobility. A good understanding of the glassy state is provided by Dominique Champion et al in “Towards an improved understanding of glass transition and relaxations in foods: molecular mobility in the glass transition range”, Trends in Food Science and Technology 11 (2000) 41-55.

Matrix components may be selected, for example, from polymers, for example proteins, polymeric carbohydrates, and other polymeric materials. The polymeric materials preferably comprise hydrophilic polymers in order to provide an effective oxygen-barrier. Accordingly, the matrix may comprise hydrocolloids. In addition, polymers being less soluble in water, that is, more hydrophobic polymers may be present in the matrix, too, in order to provide some lipophilic character to the glassy matrix and thus to provide protection against moisture. In addition, the matrix may contain further components that are not polymeric, but that may assist in the formation of a dense glassy matrix or that may be added for another purpose.

Suitable matrix components optionally associated with or part of the flavour capsules of the invention may thus comprise proteins, for example caseins, whey proteins, soy protein, and/or gelatine, for example. These proteins have good emulsification and film forming properties and can thus form the basis for polymer matrices. Preferably, the matrix components comprise carbohydrates.

The matrix component may comprise mono-, di-, tri- and/or oligosaccharides.

Preferably, the matrix component comprises polysaccharides containing more than 10 monosaccharide units per molecule. Likewise, the matrix component may comprise gums and/or hydrocolloids, such as gum arabic, and the like.

More preferably, the matrix component comprises a starch and/or a starch derivative such as pre-gelatinised starch, thin- or thick-boiling starch, dextrins or maltodextrins of various molecular weights. Other possible modifications of starch and resulting derivatives suitable as a matrix component include octenyl-succinated starch, starch ethers (i.e. carboxymethyl starch), starch esters (i.e. starch monophosphate), crosslinked starch and/or oxidised starch.

Preferably, the matrix component comprises maltodextrin and/or corn syrup. Most preferably, the matrix component comprises maltodextrin and/or corn starch syrup having a mean dextrose equivalence of 5-25, preferably 6-20, more preferably 10-18.

In a preferred embodiment, the matrix component comprises, per dry weight of the glassy matrix alone, 60-95 wt % of maltodextrin, preferably with a DE value in the above indicated ranges, and 5-40 wt. % of modified starch, such as alkenyl-succinated starch (in particular octenyl-succinated starch).

The capsules are dry added to the dry instant food of the invention. Accordingly, the capsules, which are preferably present in the form of a powdered or particulate composition, are added to a non-flavoured or incompletely flavoured instant food. This may be done shortly before finally sealing the packaging of an instant food, for example, as one of the last manufacturing steps of the instant food product. Dry-adding the flavour capsules of the invention to an instant food product provides the advantage that no flavour loss is suffered due to exposure of flavours to heat or other manufacturing steps.

According to a further embodiment of the instant food, the flavour capsules are present in a separate sachet, intended for separate addition to the instant food shortly before or during preparation of the instant food for consumption. In this embodiment, the dry instant food is a topping, a seasoning or the like.

The separate sachet may be placed in the container further housing an instant food. Before preparing the instant food for consumption, the sachet is preferably removed from the container, generally hot water is added and the contents of the sachet may be poured into the reconstituted instant food. The sachet may be made from any suitable material, e.g. plastics. The sachet may also be water-soluble. In this case it is not necessary removing the sachet from the container housing the instant food, but hot water may directly be poured into the instant food comprising the water-soluble sachet.

The capsules may be added to the instant food according to a consumer's preferences and depending on the flavour load in the capsules.

Different flavour ingredients can be present in the same capsule. For instance, several flavour ingredients and/or compounds can be premixed prior to encapsulation in the cells of a yeast in one batch as disclosed above. Alternatively, individual flavour ingredients may be separately encapsulated.

The instant food can be a topping comprising dried vegetables and/or spices, and yeast-based flavour capsules. These toppings are dry products as defined above. Dried vegetables and/or spices may be dried onions, garlic, leek, red pepper, green squash, broccoli, pepper, chili, cauliflower, ginger, and so forth. According to a preferred embodiment, the vegetable is selected from the group consisting of leek, onion, garlic, and or mixtures of any of these. More preferably the vegetable is leek.

Vegetables are preferably cut into small pieces having dimensions (length, breadths, height) in the range of about 0.001 to 100 mm, preferably 0.01 to 10 mm. Thereafter, the vegetables are dried, for example by the aid of hot air or by freeze-drying. Thereafter, the vegetables may be dry-mixed with the flavour capsules to obtain the topping of the invention.

The topping may, of course, be prepared in alternative ways. For example, the vegetable may be added to the aqueous mixture including flavours and yeast, prior to drying. In this case, the dried vegetables may form part of the matrix component.

The invention is now illustrated with reference to the following examples.

### EXAMPLES

### Example 1

### Preparation of Capsules Based on Yeast, Maltodextrin and Encapsulated Flavors

150 g spray-dried yeast (Aventine Renewable Energy Company, USA) was dispersed in 375 g water. 75 g of flavour composition (consisting of 50 wt. % onion essential oil, and 50 wt. % triacetine) are added and the mixture is maintained for 4 hours at 50° C. under constant agitation at 150 rpm in a blade stirrer.

Thereafter, 150 g of maltodextrin (DE 18) was added and mixed until homogenous.

The mixture was then spray dried on a Niro Mobile Minor® at 210° C. inlet and 90° C. outlet temperature at a feed rate of 10 ml/minute giving a powdered capsule. At the end of the process, the flavor capsules comprised 40 wt. % yeast, 40 wt. % maltodextrin and 20 wt. % liquid flavor (of which 10 wt. % is solvent and 10 wt. % is onion essence nat).

The same procedure was repeated two times with another flavour ingredient of mustard oil. Accordingly, 75 g of a flavor composition mixture (20 wt. % allylisothiocyanate and 80 wt. % triacetine) were used in the same procedure as outlined above, to obtain capsules comprising mustard flavour. The capsules comprised 40 wt. % yeast, 40 wt. % maltodextrin and 20 wt. % of the liquid flavor, hence five times less flavor compared to the pure liquid flavor.

The onion and mustard flavour capsules were further “diluted” and mixed with maltodextrin before application in food products. Accordingly, a leek flavour powdered composition comprising flavour capsules obtained above was prepared by mixing 10 wt % of onion-flavoured capsules, 5 wt. % mustard-flavoured capsules, both of which are obtained above, and 85 wt. % of maltodextrin.

### Example 2

### Preparation of Dry Flavour Topping for Use in Foods

A leek-based dry topping was prepared by cutting fresh leek into pieces having average dimensions (lengths, breadths) in the range of 0.1-100 mm and freeze-drying the leek to obtain dried leek.

The powdered leek flavour composition comprising capsules based on yeast (Example 1) were added to the dried leek at 5 wt. % to obtain a topping useful for flavouring food products, such as instant foods.

### Example 3

### Preparation of Fried Instant Noodles Comprising Dry-Added Flavour Capsules

Fried Instant Noodles are prepared on the basis of the following formulation:

| | |
|---|---|
| Instant Noodle Flour (Bogasary Flour Mill, Singapore) | 87.00% |
| Modified Starch - Elastigel 4000N (ex. National Starch) | 13.00% |
| Water | 36.00% |
| Salt | 1.50% |
| Potassium Carbonate | 0.15% |
| Sodium Carbonate | 0.10% |
| Sodium tripolyphosphate (STPP) | 0.10% |
| CMC | 0.10% |

A dough mixer is used to prepare a homogenous dough, which is put in a plastic bag. With a rolling pin, the dough is pressed to make a rectangular block.

After a rest of 10 minutes, the dough is unwrapped and sheeted and cut by the aid of a noodle machine. Thereafter, the noodles are fully gelatinized in a steamer and, after steaming, fried at 160° C. for 60 seconds. After frying, the noodles are allowed to cool.

In a first sample, the yeast-based flavour capsules of Example 1 (leek flavour powdered composition) are dry-added at 0.3 wt. % to the noodles and sealed in a plastic bag.

In a second sample, the topping obtained in Example 2, comprising dried leek and flavour capsules are dry-added at 1 wt. % to the instant noodles obtained above.

Both samples above are prepared for consumption by pouring 300 g of boiling water (100° C.) over 150 g of the instant noodles and waiting for about 3-4 minutes until the noodles are ready for consumption. Accordingly, a meal of a ready-to-consume (RTC) serving size of 450 g is obtained.

### Example 4

### Preparation of Air-Dried Instant Noodles Comprising Dry-Added Flavour Capsules

Noodles were prepared following the procedure of Example 3, with the difference that after the step of steaming the noodles, drying is performed at 60° C. for 2 hours in an air drier instead of frying.

In a first sample, the flavour capsules of Example 1 (leek flavour powdered composition) are dry-added at 0.3 wt. % to the noodles and sealed in a plastic bag. In a second sample, the topping of Example 2 is added at 1 wt. % to the noodles obtained by air-drying.

### Example 5

### In-Dough Addition of Flavour Capsules to Instant Fried Noodles

Example 3 was repeated, except that the leek flavour powdered composition of Example 1 were added at 0.3 wt. % to the dough instead of being dry-added to the fried noodles and the dough comprising the diluted capsules of Example 1 is further mixed until the capsules are fully dispersed. The remaining steps are identical to that of Example 3.

In this way, instant fried noodles comprising the yeast-based flavour capsules in the dough of the noodles are obtained.

### Example 6

### In-Dough Addition of Flavour Capsules to Instant Air Dried Noodles

Example 4 was repeated, except that the leek flavour powdered composition of Example 1 was added at 0.3 wt. % to the dough instead of being dry-added to the air-dried noodles and the dough comprising the diluted capsules of Example 1 is further mixed until the capsules are fully dispersed. The remaining steps are identical to that of Example 3.

In this way, instant air-dried noodles comprising the yeast-based flavour capsules in the dough of the noodles are obtained.

### Example 7

### Addition of Flavour Capsules in a Sachet

The onion- and mustard flavoured capsules obtained in Example 1 are mixed in an 2:1 weight ratio and the mixture of capsules is added at 1 wt. % to an edible oil in a small plastic bag (10 grams of oil and flavour capsules) and added to a cup of dried instant noodles (serving size of 150 g instant noodles), before placing the lid for sealing the cup of instant noodles.

The cup so-obtained is prepared by removing the lid and the sachet from the cup, adding boiling water to the instant noodles, adding the contents of the sachet to the instant noodles and waiting 3 minutes before consumption of the flavoured instant noodles.

1.-13. (canceled)

14. An instant food product comprising flavor capsules comprising yeast, and, encapsulated therein, a flavoring ingredient or composition, wherein the instant food product is in a dry form having a water activity of 0.5 or less when measured at 20° C.

15. The instant food product of claim 14, wherein the flavor capsules have a water content of 13 wt % or less when measured at 20° C.

16. The instant food product of claim 14, which comprises a dough-based product, and wherein the flavor capsules are present in the dough of the dough-based product.

17. The instant food product of claim 14, wherein the flavor capsules are present in a separate sachet, intended for separate addition to the instant food shortly before or during preparation.

18. The instant food product of claim 14, which is selected from the group of instant noodles, instant soups, instant rice-based meals and instant pasta-based meals.

19. The instant food product of claim 14, in which the flavor capsules are coated by a matrix component.

20. The instant food product of claim 19, in which the matrix component comprises a carbohydrate.

21. A method of preparing an instant food which comprises:
mixing yeast with water to obtain an aqueous mixture,
adding a flavor to the aqueous mixture,
stirring the aqueous mixture including the flavor until at least part of the flavor has passed into the yeast,
drying the resulting mixture, and
adding the dried capsules to a dried instant food to produce an instant food having a water activity of 0.5 or less when measured at 20° C.

22. The method of claim 21, which further comprises adding a matrix component to the aqueous mixture prior to the drying step.
